(19) United States
(12) Patent Application Publication
(10) Pub. No.: US 2007/0217665 A1
(43) Pub. Date: Sep. 20, 2007

(54) System and Method For Image-Based Tree Matching And Registration

(75) Inventors: Atilla Peter Kiraly, Plainsboro, NJ (US); Benjamin Odry, West New York, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS CORPORATE RESEARCH, INC., PRINCETON, NJ (US)

(21) Appl. No.: 11/673,621

(22) Filed: Feb. 12, 2007

Related U.S. Application Data
(60) Provisional application No. 60/772,814, filed on Feb. 13, 2006.

(51) Int. Cl. G06K 9/00

(52) U.S. Cl. 382/128

(57) ABSTRACT

A method for matching tree-structures using original image data includes providing a first tree representative of an anatomical structure in a first digital medical image of a pair of digital medical images, said tree comprising a plurality of double linked, directed branches B=(S, P, C) of sites S, links to parents P, and links to children C, providing a second tree representative of an anatomical structure in a second digital medical image of said pair of images, registering said first medical image to said second medical image wherein a registration function is defined, and matching said first tree and said second tree using said registration function.

### CROSS REFERENCE TO RELATED UNITED STATES APPLICATIONS

This application claims priority from “Image-based tree matching and registration”, U.S. Provisional Application No. 60/772,814 of Kiraly, et al., filed Feb. 13, 2006, the contents of which are herein incorporated by reference.

### TECHNICAL FIELD

This invention is directed to tree-matching algorithms in medical image processing.

### DISCUSSION OF THE RELATED ART

Tree matching algorithms can be important components of many medical image processing applications. In the case of lung imaging, they have the following applications.

1. Airway-Airway tree matching from imaging studies of the same patient taken at different times.

2. Airway-Airway tree matching from different patients.

3. Airway-Airway tree matching from one patient to an atlas in order to perform anatomic labeling.

4. Artery-Artery matching from imaging studies of the same patient taken at different times.

5. Artery-Artery matching from one patient to an atlas or another patient.

6. Airway-Artery matching within a single image in order to determine the correspondence between the two tree structures or to assist in detecting additional airway or arteries.

7. Matching of Veins to an atlas or to imaging studies of the same patient taken at different times.

Airway-Airway and Artery-Artery matching within the same patient at different times can provide an important basis for image registration and for automated quantitative analysis. For example, automatically measuring changes in bronchial wall thickness over time is possible once airway locations in sequential scans have been matched. Matching to an atlas eases several tasks for radiologists. Typically a radiologist's report identifies abnormalities using precise anatomic labeling, thus determining this data could beautomated with atlas matching. Matching with different patients allows for larger-scale comparisons of multiple patients' data. Airway-Artery matching within the same patients can be used for bronchoscopic navigation or as a basis for improved artery or airway segmentation.

Tree matching algorithms require a tree structure as input. This structure describes the tree as a series of branches interconnected through branch-points. A tree can be obtained from the image volume by several different methods including tracking, segmentation, and skeletonization. Once the tree structure is obtained, the matching algorithm operates directly on the structure and any data contained within it. Any non-looping tree structures, such as airways, arteries, and veins, contain an inherent hierarchy of parent and child branches. In fact, a tree structure can be viewed as a directed and branching graph.

The tree structure is a geometric and topologic description of the vessels or airways or any other branching tubular structure within the body. The structure is a collection of interconnected branches, each of which is comprised of a set of sites. These sites can also contain additional geometric details concerning lumen and wall measurements.

In general, there are 3 different methods of tree matching with medical data: graph matching, path matching, and point matching based methods. All have the same goal, but operate differently. Various matching requirements involve matching similar structures such as airways to airways or different structures such as airways to arteries. The matched structures can be used for automated follow-up analysis, segmentation, navigation assistance, and automated labeling.

Previous tree matching algorithms operate solely on the tree data and structure obtained from the image. These methods depend on features obtained from tree structure(s), such as branch/path lengths, branch/path angles, and hierarchy. These geometric and topological quantities, while producing good results, are dependant only on the physical properties of the tree structure obtained. Once the tree is obtained, the original image data is never referenced. Although the trees are obtained from the original data, elements from the original data are ignored.

The standard graph matching approach utilizes methods found in the classical graph matching problem from mathematics to perform a match between two given tree structures or to classify a tree structure to an anatomical map. These approaches view the tree as a graph G=(V,E) comprised of vertices V and edges E. Several possibilities exist concerning the graph definition, but in all cases, the tree structure representation must be converted into this graph structure. Information such as branch angles and branch lengths must be stored in the vertices. Finer information is such as exact path headings in the branch is lost with all current methods that rely on graph matching.

Point based matching attempts to match anatomical tree structures purely on the basis of the set of the centerline points of the tree without directly taking into account the tree structure. Each individual site or point on the tree structures are matched together based on the physical locations of other points within the tree. Hence, the matching of a branch can be decided by the branch of the corresponding tree where most of its sites were matched to.

Path-matching approaches, like point based matching, make use of the original tree structure, but are based on matching various paths through the tree. This approach potentially allows for more robustness since the matching involves all elements from the tree structure instead of “compressing” information into each vertex. Partial trees, false branches, and unspecified starting points are situations that this method is capable of handling. A metric or score is given between paths of the corresponding trees. The lower this score, the more likely that the two paths match. Since it is based on the matching of paths, the output does not always involve a completely matched tree structure. This is useful when only a single path needs to be matched, as in the case of navigational purposes.

However, there exist situations where the automatically extracted tree structure does not reliably correspond to the true anatomical tree structure or cases were the tree structure in the same patient can be distorted due to different image acquisition protocols or disease. This can be the case if the tracheo-bronchial tree is extracted from noisy, especially low-dose CT data possibly leading to false topology or disconnected sub-trees. In the extraction of the pulmonary vessel tree from multi-slice CT data, arteries and veins are in many cases not separable on basis of their Hounsfield values. This leads to the risk of artery/vein crossings being mislabeled as branching points in the tree. A solution possible by referring to the original datasets during the tree matching.

### SUMMARY OF THE INVENTION

Exemplary embodiments of the invention as described herein generally include systems and methods for an image-based feature approach to improve tree matching. According to an embodiment of the invention, the matching method, which ever one is used, make use of the original image data during matching. This allows for the use of additional information such as gray levels, or nearby objects to the tree to be used to hopefully increase the accuracy of the matching. There is potentially valuable information in the original tree data that can be used to enhance tree matching algorithms. For example, bones are rigid structures in the body that do not distort as easily as tree structures in the body. Registration of individual bone structures can give valuable additional information for tree matching. Additionally, in the opposite case, once two tree structures are matched, the similarities can be used to enhance segmentation or registration.

According to an embodiment of the invention, the original image is used along with properties derived from it to help provide better results from existing tree matching methods. This additional data is in the form of output from registration algorithms, airway-artery matching methods, or data obtained from segmentation. This data can then used to influence the scoring method for matching or labeling. Applications in which this additional data can be used for enhancing the results of the tree matching process include airway-to-airway, airway-to-artery, and airway labeling. The image features include matching points obtained from registration algorithms and additional tree structures, or other models obtained from the image. Any application involving matching or comparing vessel or tree-like structures obtained from a dataset can benefit from a method of an embodiment of the invention. The use of additional information within the original data allows for potentially greater accuracy in matching with reduced errors.

A matching method of an embodiment of the invention is useful for airway-to-artery matching where it can function both as a starting point for two paths as well as part of the feature measurements. The reverse application also benefits by this matching. Anatomically labeled or matched tree structures can benefit tasks involved in identifying or classifying re-ions from the original image(s). Registration and segmentation methods can be improved by this process.

According to an aspect of the invention, there is provided a method for matching tree-structures using original image data including providing a first tree representative of an anatomical structure in a first digital medical image of a pair of digital medical images, said tree comprising a plurality of double linked, directed branches B=(S, P, C) of sites S, links to parents P, and links to children C, providing a second tree representative of an anatomical structure in a second digital medical image of said pair of images, registering said first medical image to said second medical image wherein a registration function is defined, and matching said first tree and said second tree using said registration function.

According to a further aspect of the invention, the first medical image and second medical image are of a same patient.

According to a further aspect of the invention, the anatomical structure is an airway.

According to a further aspect of the invention, registering said first medical image to said second medical image comprises segmenting in each of said first ands second medical image lungs containing said airway, performing a lung-based registration that associates a point in the lungs of said second image to a corresponding point in the lungs of said first image.

According to a further aspect of the invention, registering said first medical image to said second medical image comprises segmenting in each of said first ands second medical image the lungs containing said airway, computing a lung slice area of slices along each of the r, y, z axes for each of the first and second lungs, and defining a transformation that associates a point in said second lungs to a corresponding point in said first lungs.

According to a further aspect of the invention, the method comprises selecting a point or structure in one of said pair of images, defining a volume-of-interest about said selected point or structure, using said registration function to find a corresponding point or structure in the other of said pair of images, defining a larger volume-of-interest about said selected point or structure in said other image, and correlating said volumes-of-interest wherein a shift vector is determined.

According to a further aspect of the invention, matching said first and second trees comprises path matching wherein a feature measure between corresponding paths in said first and second trees is calculated from an expression equivalent to
ƒ(M(pᵢ),C(M(pᵢ)|q))
wherein pᵢ represents a coordinate or direction of a point in a path in one of said first and second trees, q is a path in the other tree, M(pᵢ) represents a matching coordinate or direction in said other tree as determined from said registration function, C(M(pᵢ)|q) represents the coordinate or direction of the matching site within path q closest to pᵢ, and f is a function of M(pᵢ) and C(M(pᵢ)|q).

According to a further aspect of the invention, the function ƒ is one of a distance function equivalent to

$${\sum }_{i} {( C ( M ( {p}_{i} ) \vert q ) - M ( {p}_{i} ) )}^{2}$$

wherein M(pᵢ) and C(M(pᵢ)|q) represent matching point coordinates, an angle function

$${\sum }_{i} ∠ ( M ( {\vec{p}}_{i} ) , \vec{C} ( M ( {p}_{i} ) \vert q ) )$$

wherein M(\vec{p}ᵢ) and \vec{C}(pᵢ|q) represent matching point directions, or a distance variance function equivalent to

$${\sum }_{i} {[ {( M ( {p}_{i} ) - C ( M ( {p}_{i} ) \vert q ) )}^{2} - d ]}^{2}$$

wherein M(pᵢ) and C(M(pᵢ|q) represent matching point coordinates and d the result of the distance function, and the sums are over all points in the path.

According to a further aspect of the invention, the first tree is representative of an airway, said second tree is representative of an artery adjacent to said airway, and wherein registering said first medical image to said second medical image comprises localizing said artery using a score calculated from the sum of said region's circularity, similarity with the airway, and proximity to the airway, wherein

$$similarity = \frac{1}{\sqrt{{\sum }_{j = 0} {x}_{j}^{2}} \cdot \sqrt{{\sum }_{j = 0} {y}_{j}^{2}}} {\sum }_{i = 0}^{2} \vert {x}_{i} - {y}_{i} \vert$$

wherein xᵢ and yᵢ represent the long axis of the vessel and airway respectively,

$$circularity = \frac{N}{π \cdot {R}_{max}^{2}}$$

wherein N is the number of pixels of the structure and Rₘₐₓ is the maximum radius of the region, and

$$proximity = \frac{{D}_{airway}}{Dist}$$

wherein D_{airway} is the airway outer diameter, and Dist is the distance between the center points of the airway and artery.

According to a further aspect of the invention, matching said first and second trees comprises path matching wherein a distance measure between corresponding paths in said first and second trees is calculated from an expression equivalent to

$${\sum }_{i} {( C ( A ( {p}_{i} ) \vert q ) - A ( {p}_{i} ) )}^{2} ,$$

wherein pᵢ represents a pixel coordinate of a point in a path in one of said first and second trees, q is a path in the other tree, A(pᵢ) is a matching artery point given a point pᵢ in the airway, and C(A(pᵢ)|q) represents the site within path q closest to pᵢ.

According to a further aspect of the invention, matching said first and second trees comprises graph matching comprising, given a current location of a branch, using the distance from a matched branch to the registration mapping of the current branch as a feature for determining a match.

According to a further aspect of the invention, the first image is of a patient, said second image represents an anatomical average of the anatomical structure of the first image, wherein said second tree is provided with labels, further comprising labeling said first tree with the labels of the second tree after said trees are matched using said registration function.

According to a further aspect of the invention, matching said first and second trees comprises point-to-point matching comprising matching a point pᵢ in one tree to a point qⱼ in the other tree that minimizes a matching cost to pᵢ among all points in the other tree according to a matching cost function C defined in terms of shape feature functions ƒ^{d} of points sets of the two trees of the form
C(ƒ^{d}(M(pᵢ)),ƒ^{d}(qⱼ)),
wherein M(pᵢ) represents a matching coordinate said one tree as determined from said registration function.

According to a further aspect of the invention, the shape featured functions are one of a shape context function and a statistical moment function.

According to another aspect of the invention, there is provided a program storage device readable by a computer, tangibly embodying a program of instructions executable by the computer to perform the method steps for matching tree-structures using original image data.

### BRIEF DESCRIPTION OF THE DRAWINGS

FIG. 1 is a graph depicting examples of area curves derived from lungs for registration purposes, according to an embodiment of the invention.

FIG. 2 depicts an example of correlation between two volumes-of-interest, from two different images, according to an embodiment of the invention.

FIG. 3 depicts local evaluation of an airway, according to an embodiment of the invention.

FIG. 4 is a flowchart of a method for an image-based feature approach to tree matching, according to an embodiment of the invention.

FIG. 5 is a block diagram of an exemplary computer system for implementing a method for image-based feature approach to tree matching, according to an embodiment of the invention.

### DETAILED DESCRIPTION OF THE PREFERRED EMBODIMENTS

Exemplary embodiments of the invention as described herein generally include systems and methods for image-based feature approach to improve tree matching. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

As used herein, the term “image” refers to multidimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non medical contexts, such as, for example, remote sensing systems, electron microscopy, etc. Although an image can be thought of as a function from R³ to R, the methods of the inventions are not limited to such images, and can be applied to images of any dimension, e.g. a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

An image-based feature approach to tree matching according to an embodiment of the invention can be applied to existing graph-matching algorithms or the newer path-based matching algorithms. Specific examples of image elements that can be used from the original data to aid in better tree matching are presented herein below. Again, these elements are ignored in current tree matching methods. Specific material involving the tree structure and matching methods is first introduced since the application and examples make use of the method.

For sake of completeness, one possible, non-limiting description of a tree structure itself is described. A tree T is a collection of doubly linked, directed branches B=(S_{B}, P_{B}, C_{B}) which contains a set of equidistant sites S_{B}, links to the parents P_{B} (only one parent per branch, except for the root branch, in airways and arteries), and links to the children C_{B} (normally two or more children in airways or arteries). A branch with no parents, P_{B}=0, is defined as the root branch while branches without any children C_{B}=0 are defined as terminal branches. A set of sites S_{B} is a vector of ordered, equidistant 3-D list of coordinates with the first site defined as a start site and the last site defined as a terminal site of S_{B}. Note that the tree contains an inherent hierarchy since a branch is always considered to be a child or a parent. Hence, assuming no loops, each branch belongs to a certain generation number.

A path p is a series of sites obtained by the combination of one or more directly linked non-repeating branches starting at any site within the first branch and ending at any site of the last involved branch. A complete path is defined as a path starting at the root site of the root branch and ending at the terminal site of any terminal branch. Hence, because of this hierarchy, any complete path will always contain the root branch. Note that paths are structures without hierarchal information, i.e. all notions of parent and children branches are eliminated and one is left with a series of sites. Such tree structures may be obtained from arteries, vessels, or airways. Various methods are known in the art to obtain such structures.

In the case of graph matching, the tree structure is converted into a graph G=(V,E). Features regarding branch length and angles are then stored in the vertices. Finer levels of information such as the locations of each of the sites is lost. These features are derived from the parent and children branches. The hierarchy is preserved through the edges linking the vertices. This data structure is necessary for graph matching operations. Some examples of features include branch angle and path length. Graph matching uses association graphs to find graph isomorphisms, a well known technique. An association graph is an auxiliary graph structure derived from the two graph structures to be matched. A graph G=(V, E) consists of a set of vertices V and a set of edges E. For two graphs G₁ and G₂, an association graph G_{ag}=(V_{ag}, E_{ag}) includes the vertices V_{ag}=V₁×V₂. For example, it can contain a vertex for every possible pair of vertices in G₁ and G₂. Two vertices in G_{ag} are connected with an edge if and only if the corresponding vertices in G₁ and G₂ stand in the same relationship to each other (e.g., inheritance relationship, topological distance, etc.).

Assuming two trees T_{target} and T_{data} point to point matching attempts to relate each point of T_{data} to some point of T_{target}. A one-to-one relation between the two trees is not required. There might be portions missing in the data tree so that some points of T_{target} are not matched by any of the points of T_{data}. In addition, there may be more than one point of T_{data} associated with the same target point as its equivalent. Given a target tree T_{target} with N_{target} points pᵢ^{target} and a data tree T_{data} with N_{data} points pᵢ^{data}, any data point pᵢ^{data} is matched to the target point pⱼ^{target} giving a minimal matching cost to pᵢ^{data} among all points in the target tree:

$$j = {arg min}_{l ∈ \{ 1 , … , {N}_{target} \}} ( C ( {p}_{i}^{data} , {p}_{i}^{target} ) ) ,$$

where C is a matching cost function defined in terms of shape features. The shape features are functions of locations of a centerline point its neighborhood points and/or surrounding contour points that can capture the local shape as seen from the centerline point. Given feature vectors representing the shape at points pᵢεP, qⱼεQ, where P and Q are sets of points representing respective tree structures, a cost function can quantify the cost of matching pᵢ to qⱼ. Exemplary cost functions include:

$${C}^{{L}_{1}} ( {p}_{i} , {q}_{j} ) = {\sum }_{d = 1}^{D} \vert {f}^{d} ( {p}_{i} ) - {f}^{d} ( {q}_{j} ) \vert ;$$

$${C}^{{L}_{2}} ( {p}_{i} , {q}_{j} ) = {( {\sum }_{d = 1}^{D} {( {f}^{d} ( {p}_{i} ) - {f}^{d} ( {q}_{j} ) )}^{2} )}^{1 / 2} ;$$

$$and$$

$${C}^{{χ}^{2}} ( {p}_{i} , {q}_{j} ) = \frac{1}{2} {\sum }_{d = 1}^{D} \frac{{( {f}^{d} ( {p}_{i} ) - {f}^{d} ( {q}_{j} ) )}^{2}}{{f}^{d} ( {p}_{i} ) + {f}^{d} ( {q}_{j} )} ;$$

where ƒ(p)=(ƒ¹, . . . , ƒ^{D})(p) is a D-dimensional shape feature vector.

A branch of an extracted tree can also be compared to a branch in a data tree. A branch is defined as the part of a tree that starts at one bifurcation and ends at the next bifurcation. Thus, each branch bᵢ consists of a number of centerline points that does not overlap with any other branch, and the tree is completely made up of its branches. Branch-to-branch matching comprises matching any data point pᵢ^{data}εbⱼ^{data} to a target point pₖ^{target}εbⱼ^{target}. Thus, pᵢ^{data} votes for the branch bⱼ^{target}. If the branch bⱼ^{target} is to be matched to a target branch, each point of the data branch votes for one of the branches in the target tree. The data branch is simply matched to the target branch receiving the majority of votes. If the maximal number of votes is received by two or more branches, then the branch with the minimal sum of point matching costs is chosen.

In the case of path matching, complete paths from each tree structure are obtained and compared to each other using features to obtain a numeric value describing the similarity between two paths, where a feature is represented as a function of point locations. Instead of matching vertices or points, details from the sites of each branch are used to perform matching. The match is determined by measures between the two paths. This measure can be the result of multiple measurement values combined together.

However, the similarity from path a to path b may not equal the similarity from path b to path a depending upon the metrics used. Therefore, the matching has an associated directionality in which different results may be obtained depending on which path is chosen first. Due to this fact, the first tree is referred to as the original tree, and the second tree as the comparison tree.

As an example of a feature, the distance measure is defined as the following:

$$d = \frac{1}{{i}_{max}} {\sum }_{i} {( {p}_{i} - C ( {p}_{i} \vert q ) )}^{2} ,$$

where pᵢ=e i of the original path in image pixel coordinates and C(pᵢ|q)=closest site to pᵢ (again using image pixel coordinates) within the path q of the comparison tree, and iₘₐₓ is the total number of sites in p. This measure is computed between two roughly aligned trees and the minimum distance value between two paths can determine the match.

Another exemplary feature, the angle feature, estimates the mean difference of the directions of the two paths. Since a straight line representation of the branches is not used, each site has a direction or heading. The difference between the direction of the tangent at each site of the original path and the direction at the closest site of the comparison path is computed, and the sum of the differences for all sites is then divided by the number of points of the original path:

$$a = \frac{1}{{i}_{max}} {\sum }_{i} ∠ ( {\vec{p}}_{i} , \vec{C} ( {p}_{i} \vert q ) ) ,$$

with \vec{p}ᵢ=ion at site i of the original path and \vec{C}(pᵢ|q)=direction of the site closest to pᵢ in path q.

Another exemplary feature, the Distance Variance feature is the variance over the distance feature described earlier:

$$v = \frac{1}{{i}_{max}} {\sum }_{i} {[ {( {p}_{i} - C ( {p}_{i} \vert q ) )}^{2} - d ]}^{2}$$

with pᵢ=e i of the original path and C(pᵢ, q)=closest site of pᵢ in path q of the comparison tree and d is the mean squared distance.

Applying all three features in a comparison yields a distance vector with respect to the original path. To convert a vector into one single value, one can chose a simple combination method that takes into account the variability of each component. Components with high variability receive less weight than components with low variability. This is obtained by rescaling each component by its variance. Thus, the norm of the distance vector x equals:

$$d ≡ {‖ \overline{x} ‖}_{N} = \sqrt{{( \frac{{x}_{1}}{{σ}_{1}} )}^{2} + {( \frac{{x}_{2}}{{σ}_{2}} )}^{2} + … + {( \frac{{x}_{n}}{{σ}_{n}} )}^{2}} = \sqrt{{\overline{x}}^{T} \cdot {\overline{V}}^{- 1} \cdot \overline{x}}$$

where V̅ is the diagonal matrix of the variances of the features. V̅ is obtained by calculating the variances of each feature over all possible combinations of complete paths within the current pair of trees. In cases where only two paths are compared without considering any further paths, the variances are set to one, which results in a simple Euclidean combination. If the variance of a feature equals zero, which means it is constant over all combinations, it is useless for matching purposes, and is excluded from the combination calculation. As a result each complete path of the comparison tree can have a similarity measure to each complete path of the original tree. This similarity measure is used as a basis for the matching framework.

To match a complete tree, matching results of the various paths are considered in addition to a minimal similarity measure. A matching matrix enforces one-to-one matching. This matrix consists of all possible paths of the first tree listed in the rows, while all possible paths of the second tree are listed in the columns. Each entry in the matrix contains the similarity measure between two paths. By iteratively selecting the absolute minimal measure, labeling the involved paths as matched, and disregarding these for further matching, a strict one-to-one match constraint can be enforced. In the event of equal minimal similarity measures, one is chosen at random. Another possibility to be explored is to select the path with the greater second-lowest measure instead.

Since the original path may have no equivalent in the comparison tree, this strict one-to-one matching may end up in a chain of false labeling if an early match is done incorrectly. To avoid this situation the evaluation of the matching matrix is assisted by a probability matrix, which provides the possibility for many-to-one matching in cases where one-to-one matching is impractical. As a result, previously matched paths are available for future matches. In case the best matching path is already matched, the next best non-matched path with a measurement within tolerance becomes a higher probability than the best match. In case there are no further paths found which fulfill these requirements, a path already matched is labeled as the best match and the probability of this match and the existing matches of this path are decreased by the number of assigned matches.

Additional techniques allow hierarchy to play a part in the match. In graph matching, as branches are matched, the future matches are limited by the existing matched branches. In path matching, the use of the matching matrix provides a weak form of hierarchy. A true hierarchy can be achieved by extracting the information from existing matched paths to obtain which branches are matched within them.

In the tree matching methods described above, all features and computations relied upon the physical properties of the tree. No attempt is made to return to the original image data to acquire features that may be useful for improved matching. Such features can be incorporated into each of these three methods.

According to an embodiment of the invention, airway-to-airway matching involves obtaining two tree structures from two different images taken of the same patient. Usually the images are taken several months apart to help diagnose a course of treatment. In this case, there is additional information available in the image that is not captured by only the physical tree structure. Various registration algorithms exist that allow for matching locations to be determined from each image. It is this information that can lead to a more accurate and robust tree matching between two images. The following will describe one exemplary, non-limiting registration method according to an embodiment of the invention and its use in tree matching.

In the case of chest computed tomography (CT) data, one registration method uses the lung segmentation to produce a global correspondence of the left and right lungs from two images of the same patient. Curves of the lung areas per slice along the X, Y and Z axes are computed and correlated to define a lookup table of slice correspondence. It is assumed that the correspondence can be modeled as an affine transformation:
(slice i from image 1)=A×(slice j from image 2)+B.
The reversed look-up table is thus used as a global registration process to estimate corresponding slices in the first or the second images.

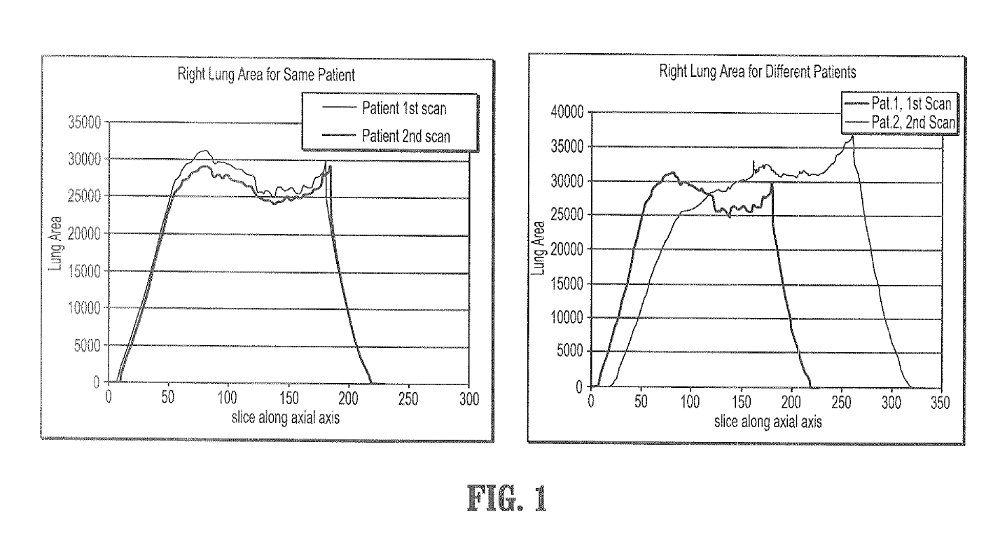

FIG. 1 is a graph depicting examples of area curves along the Z axis. The left side example depicts area curves between two images of the same patient, and the right side example depicts area curves of images from two different patients. Note that the curve shape is distinctive for a patient.

Although the global registration gives a shift along the X, Y and Z directions, in an embodiment of the invention a tuning step is added for a more accurate correspondence of the points. Once a point/structure has been selected in either of the images, a surrounding volume-of-interest (VOI) is defined and the structures' boundaries are selected for later matching. Using the global registration one finds the counterpart point in the second image and defines a larger surrounding VOI. A correlation between the two VOIs can be used to determine the best shifts to estimate the counterpart position.

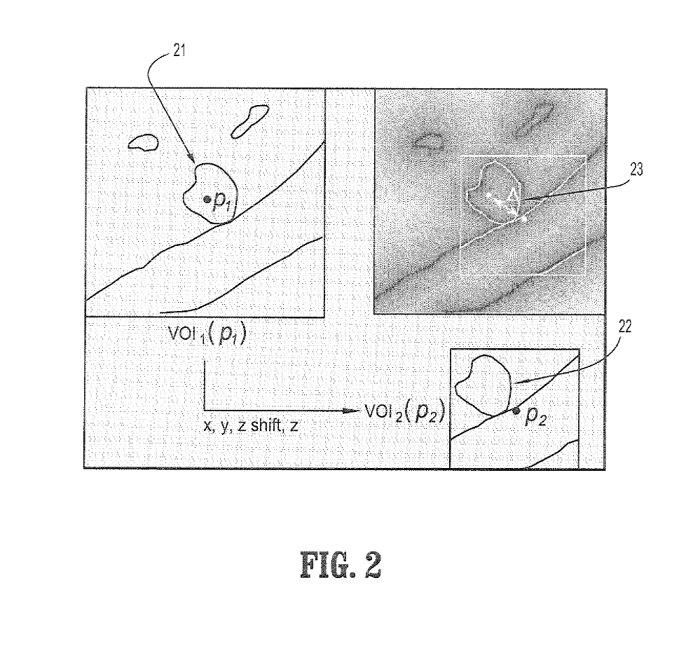

FIG. 2 depicts an example of correlation between two VOIs from two different images. In the upper left, VOI₁ 21 is created around p₁. Using an iterative procedure, VOI₂ 22 is moved along updated x, 3; z shifts and the correlation is computed. A distance transformation is used to compute a delta 23 between the VOIs.

The result of this registration method of an embodiment of the invention allows a single point in the first image to be matched to another point in the second image and vice-versa. A new measurement can easily incorporate this point-to-point match in the case of path-based matching. Let M(pᵢ) be the matching point in the second image to the given point pᵢ in the first image. Then a new distance measurement for path-matching can be defined as:

$$d = \frac{1}{{i}_{max}} {\sum }_{i} {( C ( M ( {p}_{i} ) \vert q ) - M ( {p}_{i} ) )}^{2} .$$

In this case, the mapped point of pᵢ is used in comparison to the path q.

This is just one possible example of a measure for path matching. Similar measures using the registration function can be defined for the angle feature and the distance variance feature. For example, a new angle feature could defined with M(\vec{p}ᵢ)=direction at matched site i of the original path and \vec{C}(M(pᵢ)|q)=direction of the matched site closest to the match of pᵢ in path q, and a new distance variance feature can be defined using the mapped point of pᵢ is used in comparison to the path q and the new distance result.

In this example, no alignment of the trees is necessary. By tree alignment is meant actually shifting the two trees so that they roughly line up with each other. For example, consider two points that are 2 meters apart. If one point is moved closer to the other, the distance measurement is reduced. The way the distance measurement is performed is not affected, only the measured value that is obtained is changed. A measurement assuming tree alignment can also be used by either combining this measure with one that makes use of alignment or by using a value involving alignment within the measurement equation.

A graph-matching based approach according to an embodiment of the invention can compress matched points into the vertices. For example, given the location of a branch point, the distance from the matched node to the mapping of the current node can be used as an additional feature for graph matching. Given that this distance value would be lower for proper matches, its can be directly incorporated into the graph-matching method. For example, graph matching techniques use branch angles stored in the nodes of as a feature. This distance value would be used as an additional feature in determining the match.

Similarly, with point to point matching, registration information between T_{target} and T_{data} can be used in calculating the shape feature functions of the one of the trees, which are in turn used in the cost functions. In particular, since the cost functions are functions of feature functions calculated on points sets involving the two trees, typically of the form
C(pᵢ,qⱼ)=C(ƒ^{d}(pᵢ),ƒ^{d}(qⱼ)),
where the feature functions ƒ can be functions such as the shape context and statistical moments defined above, then, according to an embodiment of the invention, the coordinates of one of the pair of feature functions can be replaced by their respective registration mappings:
C(pᵢ, qⱼ)=C(ƒ^{d}(M(pᵢ)),ƒ^{d}(qⱼ)).

One type of feature function is the shape context, defined at a point q in 3D as:

$${SC}_{q} ( j , k , l ) = {\sum }_{{d}_{i} ∈ bin ( j , k , l )} w ( {d}_{i} ) ,$$

where the displacement vector dᵢ=pᵢ−q where pᵢ is a point in the neighborhood of q, and w(dᵢ) is a weight with which dᵢ contributes to the sum. The displacement vector dᵢ can be expressed in spherical coordinates as

$${d}_{i} = {r}_{i} [ \begin{matrix}cos ( {φ}_{i} ) sin ( {ϑ}_{i} ) \\ sin ( {φ}_{i} ) sin ( {ϑ}_{i} ) \\ cos ( {ϑ}_{i} )\end{matrix} ] ,$$

and the membership of displacement dᵢ in a histogram bin is given by
dᵢεbin(j,k,l) [symbol] φᵢε└Ψⱼ,Ψⱼ₊₁), [symbol] ᵢε[Θₖ,Θₖ₊₁),rᵢε[Rₗ,Rₗ₊₁),
where the angles [symbol] and φ are quantized linearly:

$$\begin{matrix}{Φ}_{j} = \frac{2 π j}{J} , & j ∈ \{ 0 , … , J \} , \\ {Θ}_{k} = \frac{2 π k}{K} , & k ∈ \{ 0 , … , K \} ,\end{matrix}$$

and the radius is quantized logarithmically as

$${R}_{l} = exp ( ln ( {r}_{min} ) + \frac{l}{L} ln ( \frac{{r}_{max}}{{r}_{min}} ) ) .$$

Another feature function is the statistical moment. In general, 3D moments of order n=j+k+l of a 3D density function ƒ(x,y,z) are defined by
mⱼₖₗ=∫∫∫_{R}^{₃}x^{j}y^{k}z^{l}ƒ(x,y,z)dxdydz,
or, in the discrete case,

$${m}_{pqr} = {\sum }_{i = 1}^{N} {x}_{k}^{j} {y}_{k}^{k} {z}_{k}^{l} .$$

The coordinates x,y,z are components of a displacement vector dᵢ=pᵢ−q, defined as above. To calculate a feature vector at a reference point based on moments, the 3D tree structure and the relative positions of all remaining points need to be provided, after which all moments or order up to some value n=nₘₐₓ are calculated. The feature vector is constructed by concatenating all acquired statistical moments:
ƒ=(μ₁₀₀,μ₀₁₀,μ₀₀₁,μ₂₀₀, . . . ,μ₀₀ₙ_{ₘₐₓ}),
where each moment in the feature vector is adjusted depending on its order n=j+k+l by
μⱼₖₗ=^{j+k+l}\sqrt{mⱼₖₗ}
to involve all moments equally in a shape distance calculation. The feature vector has s dimensions where

$$s = \frac{( {n}_{max} + 3 ) !}{3 ! {n}_{max} !} - 1.$$

As can be seen from this non-limiting example according to an embodiment of the invention, methods according to an embodiment of the invention that make use of other portions of the image not used in existing tree matching methods can increase accuracy and robustness. As stated before, assuming there are matched trees, this information can be used vice-versa. Given an arbitrary registration method for the area of the body with the matched trees, the trees can be used as part of the registration method to increase accuracy and robustness.

According to another embodiment of the invention, the original image data can be used to provide additional data for artery-airway matching. A method according to this embodiment of the invention allows for determining the position of the artery adjacent to a selected airway for computing a broncho-arterial ratio, an indicator of airway wellness. The artery is localized by labeling high-intensity regions in a cross-sectional plane of the airway branch, and calculating the following feature values.

$$similarity = \frac{1}{\sqrt{{\sum }_{j = 0} {x}_{j}^{2}} \cdot \sqrt{{\sum }_{j = 0} {y}_{j}^{2}}} {\sum }_{i = 0}^{2} \vert {x}_{i} \cdot {y}_{i} \vert$$

with xᵢ and yᵢ being the long axis of the vessel and airway respectively;

$$circularity = \frac{N}{π \cdot {R}_{max}^{2}}$$

with N being the number of pixels of the structure and Rₘₐₓ being the maximum radius of the structure;
and

$$proximity = \frac{{D}_{airway}}{Dist}$$

with D_{airway} being the airway outer diameter, and Dist being the distance between the center points of the airway and artery.

These features measure physical properties of the artery and its location relative to the airway. The similarity measures the similarity of the heading of the airway and artery. The circularity measures how circular the artery is. The proximity describes the physical distance between the airway and artery. These feature values are summed to define a score that is used as a metric of the likelihood of the artery and airway being a good match. This is used to select a candidate for being a good match. If the score is too low, then it is assumed that no match was found. The highest score will identify the artery. Once the adjacent artery is identified, its diameter is estimated for the broncho-arterial ratio computation.

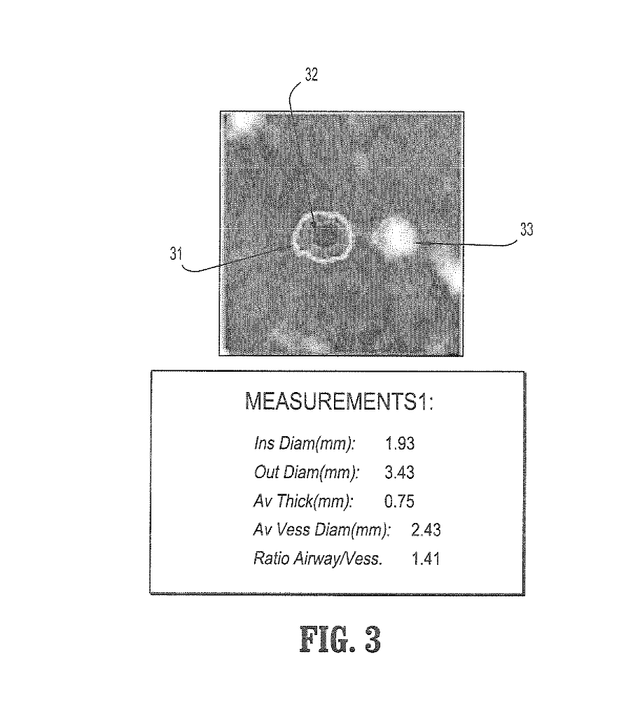

FIG. 3 depicts an exemplary local evaluation of the airway, shown in the plane perpendicular to the airway. The artery is identified using the grayscale values of original volume. The inner 31 and outer 32 diameters of the airway are shown along with the extracted measurements. The adjacent artery diameter 33 is also outlined, and the airway/artery ratio is indicated.

This registration method according to an embodiment of the invention allows one to determine a corresponding arterial location given the location of the airway. Previous automated approaches of airway-to-artery matching were performed using a graph-matching approach involving only the tree structures. In this situation, the airway and arterial trees were compared. However, one issue with this method was the fact that the root of the arterial tree and that of the airway do not correspond and are not always available as part of the tree structure. The path-matching approach deals with this issue by taking the closest sites for the measurement criteria. However, by using the original image data via registration, more exact sites close to the given airway tree can be determined.

In another exemplary embodiment of the invention involving the distance formula given above, let A(pᵢ) define a matching artery point given the point pᵢ from the airway. Then there is a new distance feature measure that makes use of the original image data via the registration method:

$$d = \frac{1}{{i}_{max}} {\sum }_{i} {( C ( A ( {p}_{i} ) \vert q ) - A ( {p}_{i} ) )}^{2} .$$

This is the same formula as shown in the airway-to-airway matching example except for a different registration function. The match point function A can also be used to select a starting point for matching the airway and arterial paths. This is useful because the artery tends to start after the airway tree but goes further. It can also be used to define a sub-section of the paths for matching.

Once the airway paths and arterial paths are matched, it is also possible to use this information to improve the segmentation of the airways. Since the arterial segmentation can achieve better results than airway segmentation and that airways and arteries correspond within the lungs, airway searches near the matched arteries can be specified along with an anticipated hierarchy. This information can also be used to help separate arteries from veins.

Another application of an embodiment of the invention is anatomical labeling, wherein standardized labels or regions are assigned to a tree structure. Each branch of the tracheo-bronchial tree extracted from a computed tomography (CT) dataset is labeled as one of 34 anatomical structures. Anatomical labels are assigned by matching the target tree against a prelabeled tree that represents a population average and contains information about the geometrical and topological properties of the human airway tree. This has been previously applied to airway trees using a graph-matching approach. However, as in the previous cases, only the tree structure was used in this process. Variances in anatomy and false-branches can create problems for this approach since it is based only on graph matching.

In the case of airway trees, certain anatomical structures exist near specific airways that can be used for improved anatomical labeling. For example, the five lobes of the lung each have different regions of the airway entering them. Given a lobe segmentation of the original data, a more accurate determination of the anatomical labels can be obtained. According to an embodiment of the invention, pre-labeled models can include lobe information, which can then be used for matching. Note that in standard tree matching, lobe information cannot be used since it does not relate to the physical tree structure. Knowing to which lobe a specific branch belongs allows one to further constrain the possible matches. The same holds for labeling of the arterial vessel tree. In addition, given a tree model of the arteries near the heart, the relative locations of the airways can be used as a feature in providing more accurate anatomical labels to the arteries. In these examples, it can be seen that data within the original volume can be used to provide enhanced anatomical labeling.

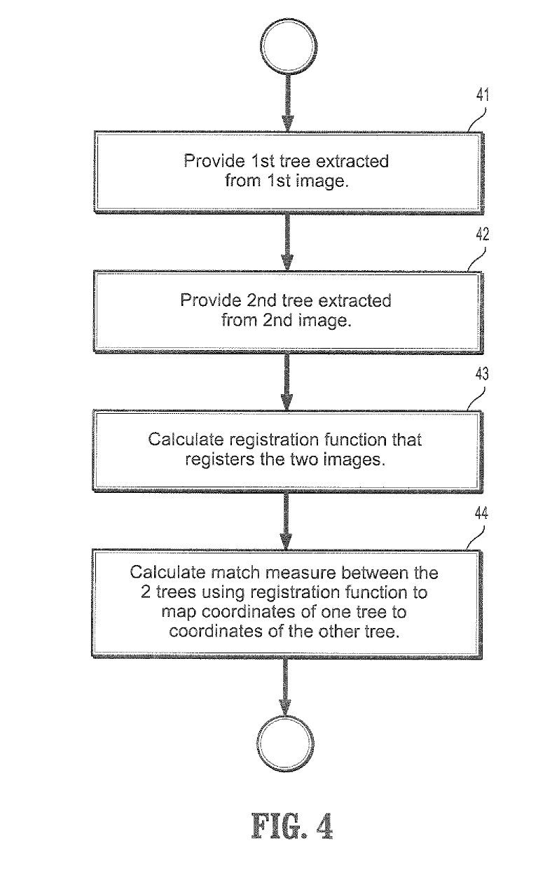

A flowchart of a matching method according to an embodiment of the invention is depicted in FIG. 4. Referring now to the figure, a first tree representative of an anatomical structure in a first digital medical image is provided at step 41, and a second tree representative of an anatomical structure in a second digital medical image is provided in step 42. Note that the images can be of the same patient at different times, of two different patients, or one image could be of a patient and the other image could be an averaged image taken from an anatomical atlas. At step 43, a registration function is calculated that registers the two images. At step 44, a matching function is calculated between the two trees, using the registration information to map the coordinates of points in one tree to points of the other tree. The matching function can be one of the distance, angle, or distance variance functions described above, used in path matching, of the match could be calculated from a cost function that compares shape features of the two trees, where the shape features of one tree are calculated using registered point coordinates. Alternatively, in the case of graph matching, registered branch coordinates could be used as another feature used to determine the association graph.

It is to be understood that embodiments of the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

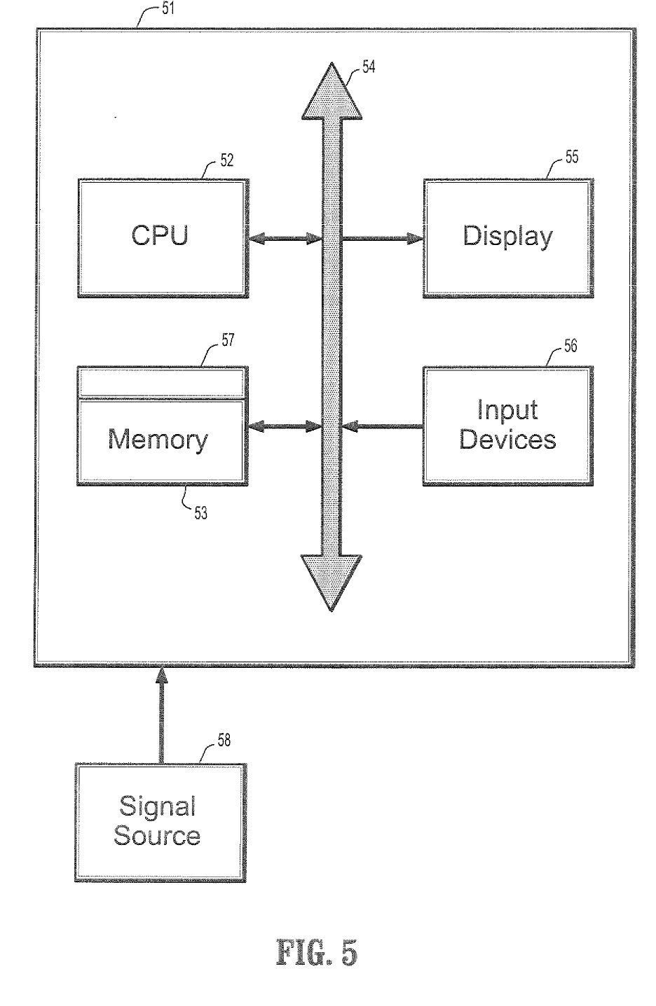

FIG. 5 is a block diagram of an exemplary computer system for implementing a image feature based tree matching method according to an embodiment of the invention. Referring now to FIG. 5, a computer system 51 for implementing the present invention can comprise, inter alia, a central processing unit (CPU) 52, a memory 53 and an input/output (I/O) interface 54. The computer system 51 is generally coupled through the I/O interface 54 to a display 55 and various input devices 56 such as a mouse and a keyboard. The support circuits can include circuits such as cache, power supplies, clock circuits, and a communication bus. The memory 53 can include random access memory (RAM), read only memory (ROM), disk drive, tape drive, etc., or a combinations thereof. The present invention can be implemented as a routine 57 that is stored in memory 53 and executed by the CPU 52 to process the signal from the signal source 58. As such, the computer system 51 is a general purpose computer system that becomes a specific purpose computer system when executing the routine 57 of the present invention.

The computer system 51 also includes an operating system and micro instruction code. The various processes and functions described herein can either be part of the micro instruction code or part of the application program (or combination thereof which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present invention is programmed. Given the teachings of the present invention provided herein, one of ordinary skill in the related art will be able to contemplate these and similar to implementations or configurations of the present invention.

While the present invention has been described in detail with reference to a preferred embodiment, those skilled in the art will appreciate that various modifications and substitutions can be made thereto without departing from the spirit and scope of the invention as set forth in the appended claims.

What is claimed is:

1. A method for matching tree-structures using original image data comprising the steps of:
providing a first tree representative of an anatomical structure in a first digital medical image of a pair of digital medical images, said tree comprising a plurality of double linked, directed branches B=(S, P, C) of sites S, links to parents P, and links to children C;
providing a second tree representative of an anatomical structure in a second digital medical image of said pair of images;
registering said first medical image to said second medical image wherein a registration function is defined; and
matching said first tree and said second tree using said registration function.

2. The method of claim 1, wherein said first medical image and second medical image are of a same patient.

3. The method of claim 1, wherein said anatomical structure is an airway.

4. The method of claim 3, wherein registering said first medical image to said second medical image comprises segmenting in each of said first ands second medical image lungs containing said airway, performing a lung-based registration that associates a point in the lungs of said second image to a corresponding point in the lungs of said first image.

5. The method of claim 4, wherein registering said first medical image to said second medical image comprises segmenting in each of said first ands second medical image the lungs containing said airway, computing a lung slice area of slices along each of the x, y, z axes for each of the first and second lungs, and defining a transformation that associates a point in said second lungs to a corresponding point in said first lungs.

6. The method of claim 5, further comprising selecting a point or structure in one of said pair of images, defining a volume-of-interest about said selected point or structure, using said registration function to find a corresponding point or structure in the other of said pair of images, defining a larger volume-of-interest about said selected point or structure in said other image, and correlating said volumes-of-interest wherein a shift vector is determined.

7. The method of claim 1, wherein matching said first and second trees comprises path matching wherein a feature measure between corresponding paths in said first and second trees is calculated from an expression equivalent to
ƒ(M(pᵢ),C(M(pᵢ|q))
wherein pᵢ represents a coordinate or direction of a point in a path in one of said first and second trees, q is a path in the other tree, M(pᵢ) represents a matching coordinate or direction in said other tree as determined from said registration function, C(M(pᵢ|q) represents the coordinate or direction of the matching site within path q closest to pᵢ, and f is a function of M(pᵢ) and C(M(pᵢ)|q).

8. The method of claim 7, wherein said function ƒ is one of a distance function equivalent to
$${\sum }_{i} {( C ( M ( {p}_{i} ) \vert q ) - M ( {p}_{i} ) )}^{2}$$
wherein M(pᵢ) and C(M(pᵢ)|q) represent matching point coordinates, an angle function
$${\sum }_{i} ∠ ( M ( {\vec{p}}_{i} ) , \vec{C} ( M ( {p}_{i} ) \vert q ) )$$
wherein M(\vec{p}ᵢ) and \vec{C}(pᵢ|q) represent matching point directions, or a distance variance function equivalent to
$${\sum }_{i} {[ {( M ( {p}_{i} ) - C ( M ( {p}_{i} ) \vert q ) )}^{2} - d ]}^{2}$$
wherein M(pᵢ) and C(M(pᵢ)|q) represent matching point coordinates and d the result of the distance function, and the sums are over all points in the path.

9. The method of claim 1, wherein said first tree is representative of an airway, said second tree is representative of an artery adjacent to said airway, and wherein registering said first medical image to said second medical image comprises localizing said artery using a score calculated from the sum of said region's circularity, similarity with the airway, and proximity to the airway, wherein
$$similarity = \frac{1}{\sqrt{{\sum }_{j = 0} {x}_{j}^{2}} \cdot \sqrt{{\sum }_{j = 0} {y}_{j}^{2}}} {\sum }_{i = 0}^{2} \vert {x}_{i} \cdot {y}_{i} \vert$$
wherein xᵢ and yᵢ represent the long axis of the vessel and airway respectively,
$$circularity = \frac{N}{π \cdot {R}_{max}^{2}}$$
wherein N is the number of pixels of the structure and Rₘₐₓ is the maximum radius of the region, and
$$proximity = \frac{{D}_{airway}}{Dist}$$
wherein D_{airway} is the airway outer diameter, and Dist is the distance between the center points of the airway and artery.

10. The method of claim 9, wherein matching said first and second trees comprises path matching wherein a distance measure between corresponding paths in said first and second trees is calculated from an expression equivalent to
$${\sum }_{i} {( C ( A ( {p}_{i} ) \vert q ) - A ( {p}_{i} ) )}^{2} ,$$
wherein pᵢ represents a pixel coordinate of a point in a path in one of said first and second trees, q is a path in the other tree, A(pᵢ) is a matching artery point given a point pᵢ in the airway, and C(A(pᵢ)|q) represents the site within path q closest to pᵢ.

11. The method of claim 1, wherein matching said first and second trees comprises graph matching comprising, given a current location of a branch, using the distance from a matched branch to the registration mapping of the current branch as a feature for determining a match

12. The method of claim 1, wherein said first image is of a patient, said second image represents an anatomical average of the anatomical structure of the first image, wherein said second tree is provided with labels, further comprising labeling said first tree with the labels of the second tree after said trees are matched using said registration function.

13. The method of claim 1, wherein matching said first and second trees comprises point-to-point matching comprising matching a point pᵢ in one tree to a point qⱼ in the other tree that minimizes a matching cost to pᵢ among all points in the other tree according to a matching cost function C defined in terms of shape feature functions ƒ^{d} of points sets of the two trees of the form
C(ƒ^{d}(M(pᵢ)),ƒ^{d}(qⱼ)),
wherein M(pᵢ) represents a matching coordinate said one tree as determined from said registration function.

14. The method of claim 13, wherein the shape featured functions are one of a shape context function and a statistical moment function.

15. A method of matching tree-structures obtained from medical image data comprising steps of:
obtaining a plurality of tree structures, each tree structure being obtained from either a medical image or a medical atlas; and
matching said tree structures using data obtained from the images and atlases.

16. The method of claim 16, wherein matching said tree structures using said image or atlas data comprises, for each pair of images to be matched, calculating a registration function that maps points in one imager to corresponding points is the other of said pair of images.

17. A program storage device readable by a computer, tangibly embodying a program of instructions executable by the computer to perform the method steps for matching tree-structures using original image data comprising the steps of:
providing a first tree representative of an anatomical structure in a first digital medical image of a pair of digital medical images, said tree comprising a plurality of double linked, directed branches B=(S, P, C) of sites S, links to parents P, and links to children C;
providing a second tree representative of an anatomical structure in a second digital medical image of said pair of images;
registering said first medical image to said second medical image wherein a registration function is defined; and
matching said first tree and said second tree using said registration function.

18. The computer readable program storage device of claim 17, wherein said first medical image and second medical image are of a same patient.

19. The computer readable program storage device of claim 17, wherein said anatomical structure is an airway.

20. The computer readable program storage device of claim 19, wherein registering said first medical image to said second medical image comprises segmenting in each of said first ands second medical image lungs containing said airway, performing a lung-based registration that associates a point in the lungs of said second image to a corresponding point in the lungs of said first image.

21. The computer readable program storage device of claim 20, wherein registering said first medical image to said second medical image comprises segmenting in each of said first ands second medical image the lungs containing said airway, computing a lung slice area of slices along each of the x, y, z axes for each of the first and second lungs, and defining a transformation that associates a point in said second lungs to a corresponding point in said first lungs.

22. The computer readable program storage device of claim 21, the method further comprising selecting a point or structure in one of said pair of images, defining a volume-of-interest about said selected point or structure, using said registration function to find a corresponding point or structure in the other of said pair of images, defining, a larger volume-of-interest about said selected point or structure in said other image, and correlating said volumes-of-interest wherein a shift vector is determined.

23. The computer readable program storage device of claim 17, wherein matching said first and second trees comprises path matching wherein a feature measure between corresponding paths in said first and second trees is calculated from an expression equivalent to
ƒ(M(pᵢ),C(M(pᵢ)|q))
wherein pᵢ represents a coordinate or direction of a point in a path in one of said first and second trees, q is a path in the other tree, M(pᵢ) represents a matching coordinate or direction in said other tree as determined from said registration function, C(M(pᵢ)|q) represents the coordinate or direction of the matching site within path q closest to pᵢ, and f is a function of M(pᵢ) and C(M(pᵢ)|q).

24. The computer readable program storage device of claim 23, wherein said function ƒ is one of a distance function equivalent to
$${\sum }_{i} {( C ( M ( {p}_{i} ) \vert q ) - M ( {p}_{i} ) )}^{2}$$
wherein M(pᵢ) and C(M(pᵢ)|q) represent matching point coordinates, an angle function
$${\sum }_{i} ∠ ( M ( {{p}^{->}}_{i} ) , {C}^{->} ( M ( {p}_{i} ) \vert q ) )$$
wherein M(\vec{p}ᵢ) and \vec{C}(pᵢ|q) represent matching point directions, or a distance variance function equivalent to
$${\sum }_{i} {[ {( M ( {p}_{i} ) - C ( M ( {p}_{i} ) \vert q ) )}^{2} - d ]}^{2}$$
wherein M(pᵢ) and C(M(pᵢ)|q) represent matching point coordinates and d the result of the distance function, and the sums are over all points in the path.

25. The computer readable program storage device of claim 17, wherein said first tree is representative of an airway, said second tree is representative of an artery adjacent to said airway, and wherein registering said first medical image to said second medical image comprises localizing said artery using a score calculated from the sum of said region's circularity, similarity with the airway, and proximity to the airway, wherein
$$similarity = \frac{1}{\sqrt{{\sum }_{j = 0} {x}_{j}^{2}} \cdot \sqrt{{\sum }_{j = 0} {y}_{j}^{2}}} {\sum }_{i = 0}^{2} \vert {x}_{i} , {y}_{i} \vert$$
wherein xᵢ and yᵢ represent the long axis of the vessel and airway respectively,
$$circularity = \frac{N}{π \cdot {R}_{max}^{2}}$$
wherein N is the number of pixels of the structure and Rₘₐₓ is the maximum radius of the region, and
$$proximity = \frac{{D}_{airway}}{Dist}$$
wherein D_{airway} is the airway outer diameter, and Dist is the distance between the center points of the airway and artery.

26. The computer readable program storage device of claim 25, wherein matching said first and second trees comprises path matching wherein a distance measure between corresponding paths in said first and second trees is calculated from an expression equivalent to
$${\sum }_{i} {( C ( A ( {p}_{i} ) \vert q ) - A ( {p}_{i} ) )}^{2} ,$$
wherein pᵢ represents a pixel coordinate of a point in a path in one of said first and second trees, q is a path in the other tree, A(pᵢ) is a matching artery point given a point pᵢ in the airway, and C(A(pᵢ)|q) represents the site within path q closest to pᵢ.

27. The computer readable program storage device of claim 17, wherein matching said first and second trees comprises graph matching comprising, given a current location of a branch, using the distance from a matched branch to the registration mapping of the current branch as a feature for determining a match

28. The computer readable program storage device of claim 17, wherein said first image is of a patient, said second image represents an anatomical average of the anatomical structure of the first image, wherein said second tree is provided with labels, further comprising labeling said first tree with the labels of the second tree after said trees are matched using said registration function.

29. The computer readable program storage device of claim 17, wherein matching said first and second trees comprises point-to-point matching comprising matching a point pᵢ in one tree to a point qⱼ in the other tree that minimizes a matching cost to pᵢ among all points in the other tree according to a matching cost function C defined in terms of shape feature functions ƒ^{d} of points sets of the two trees of the form
C(ƒ^{d}(M(pᵢ)),ƒ^{d}(qⱼ)),
wherein M(pᵢ) represents a matching coordinate said one tree as determined from said registration function.

30. The computer readable program storage device of claim 29, wherein the shape featured functions are one of a shape context function and a statistical moment function.
